(19) United States
(12) Patent Application Publication
(10) Pub. No.: US 2022/0066472 A1
(43) Pub. Date: Mar. 3, 2022

(54) UNMANNED AERIAL VEHICLE RETURN METHOD, DEVICE, UNMANNED AERIAL VEHICLE, AND STORAGE MEDIUM

(71) Applicant: SZ DJI TECHNOLOGY CO., LTD., Shenzhen (CN)

(72) Inventor: Liyao ZHAO, Shenzhen (CN)

(21) Appl. No.: 17/522,355

(22) Filed: Nov. 9, 2021

Related U.S. Application Data
(63) Continuation of application No. PCT/CN2019/089029, filed on May 29, 2019.

(51) Int. Cl. G05D 1/10; G05D 1/08; G05D 1/04; B64C 39/02

(52) U.S. Cl. CPC G05D 1/101; G05D 1/0808; B64C 2201/14; B64C 39/024; G05D 1/042

(57) ABSTRACT

An unmanned aerial vehicle (UAV) return method includes controlling a UAV to ascend vertically to a first preset position, controlling the UAV to fly from the first preset position to a second preset position along a horizontal direction, controlling the UAV to fly from the second preset position to a third preset position along a flight tilt angle direction indicated by a flight tilt angle, and controlling the UAV to land vertically from the third preset position to a preset return position. The second preset position is determined according to position information of the first preset position, position information of the third preset position, and a flight tilt angle. The third preset position is above the preset return position.

### CROSS-REFERENCE TO RELATED APPLICATION

This application is a continuation of International Application No. PCT/CN2019/089029, filed May 29, 2019, the entire content of which is incorporated herein by reference.

### TECHNICAL FIELD

The present disclosure relates to the field of unmanned aerial vehicle (UAV) and, more particularly, to a UAV return method, device, UAV, and storage medium.

### BACKGROUND

As commercial unmanned aerial vehicles (UAVs) increasingly used in people's daily life and various industries, the safety of UAVs becomes more and more important. The UAV automatic return technic is an essential part to ensure the safety of the UAV. The UAV automatic return refers to that the UAV automatically selects a path to return to a preset return position (Home point) without human intervention.

In some related technologies, the following manners are generally used to perform the automatic return. The UAV ascends vertically to a preset height, then the UAV moves forward along a horizontal straight line to directly above the return point. Finally, the UAV descends vertically to the ground of the return destination. In the above-described manner, since the UAV's vertical descent speed is slow, the process of descending from a high-altitude costs more time and electricity, so that the automatic return process requires more time and electricity. Since the endurance of the UAV is generally short, the risk of the UAV falling from the air due to low power during the automatic return process is greatly increased.

### SUMMARY

In accordance with the disclosure, there is provided an unmanned aerial vehicle (UAV) return method including controlling a UAV to ascend vertically to a first preset position, controlling the UAV to fly from the first preset position to a second preset position along a horizontal direction, controlling the UAV to fly from the second preset position to a third preset position along a flight tilt angle direction indicated by the flight tilt angle, and controlling the UAV to land vertically from the third preset position to a preset return position. The second preset position is determined according to position information of the first preset position, position information of the third preset position, and a flight tilt angle. The third preset position is above a preset return position.

Also in accordance with the disclosure, there is provided a control device including a storage medium storing instructions and a processor configured to execute the instructions to control an unmanned aerial vehicle (UAV) to ascend vertically to a first preset position, control the UAV to fly from the first preset position to a second preset position along a horizontal direction, control the UAV to fly from the second preset position to a third preset position along a flight tilt angle direction indicated by the flight tilt angle, and control the UAV to land vertically from the third preset position to a preset return position. The second preset position is determined according to position information of the first preset position, position information of the third preset position, and a flight tilt angle. The third preset position is above a preset return position.

Also in accordance with the disclosure, there is provided an unmanned aerial vehicle (UAV) including a UAV body, a propulsion system arranged at the UAV body and configured to provide propulsion for the UAV to move, and a control device. The control device includes a storage medium storing instructions and a processor configured to execute the instructions to control the UAV to ascend vertically to a first preset position, control the UAV to fly from the first preset position to a second preset position along a horizontal direction, control the UAV to fly from the second preset position to a third preset position along a flight tilt angle direction indicated by the flight tilt angle, and control the UAV to land vertically from the third preset position to a preset return position. The second preset position is determined according to position information of the first preset position, position information of the third preset position, and a flight tilt angle. The third preset position is above a preset return position.

### BRIEF DESCRIPTION OF THE DRAWINGS

FIG. 1 is a schematic flow chart of an unmanned aerial vehicle (UAV) return method according to some embodiments of the present disclosure.

FIG. 2 is a schematic diagram of a UAV return method according to some embodiments of the present disclosure.

FIG. 3 is a schematic diagram of another UAV return method according to some embodiments of the present disclosure.

FIG. 4 is a schematic flow chart of another UAV return method according to some embodiments of the present disclosure.

FIG. 5 is a schematic structural diagram of a UAV control device according to some embodiments of the present disclosure.

### DETAILED DESCRIPTION OF THE EMBODIMENTS

To make purposes, technical solutions, and advantages of the present disclosure clearer, the technical solutions in embodiments of the present disclosure are described in conjunction with accompanying drawings in embodiments of the present disclosure. The described embodiments are some embodiments not all the embodiments of the present disclosure. Based on the embodiments of the disclosure, all other embodiments obtained by those of ordinary skill in the art without any creative work are within the scope of the present disclosure.

Embodiments of the present disclosure provide an unmanned aerial vehicle (UAV) return method. The return method may be used in the UAV return scenario to reduce a return time and the usage of battery power of the UAV. The method may be executed by a UAV control device. The UAV control device may be integrated with the UAV or separated from the UAV. The embodiments of the present disclosure are not limited thereto.

The UAV provided by the embodiments may be a multi-rotor UAV. In some embodiments, the UAV may be a quadrotor UAV, a hexarotor UAV, or an octorotor UAV. The UAV of the present disclosure may be a vertical take-off-landing UAV or a fixed-wing UAV.

Methods provided by the embodiments of the present disclosure may be implemented by a UAV control device, such as a processor. The processor may execute the software code to implement the return method. The method may also be implemented by the UAV control device executing the corresponding software code while performing data interaction with a server. For example, the server performs part of the operations to control the UAV control device to execute the UAV return method.

Technical solutions of the present disclosure will be described below with specific embodiments. The following specific embodiments may be combined with each other. For the same or similar concepts or processes, the description may not be repeated in some embodiments.

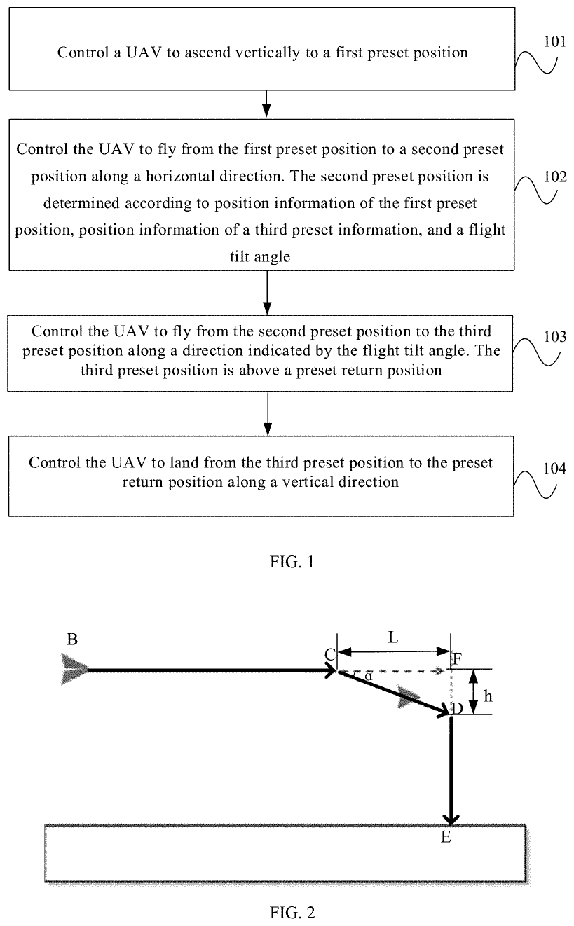

FIG. 1 is a schematic flow chart of a UAV return method according to some embodiments of the present disclosure. As shown in FIG. 1 and FIG. 2, a method provided by the embodiments includes the following.

At 101, the UAV is controlled to ascend vertically to a first preset position.

In some embodiments, when the UAV is returning, the UAV is controlled to ascend vertically from an initial position (the initial position is the position of the UAV when the UAV starts to return automatically) to the first preset position. A height of the first preset position may be determined according to the environment of the area that the UAV passes through during the returning process, that is, the height of the first preset position may be preset based on the flight safety consideration of the UAV.

At 102, the UAV is controlled to fly from the first preset position to a second preset position along a horizontal direction. The second position is determined according to position information of the first preset position, position information of a third preset position, and a flight tilt angle.

In some embodiments, the second preset position needs to be determined before the UAV is controlled to fly from the first preset position to the second preset position along the horizontal direction. The second preset position may be determined according to the position information of the first preset position, the position information of the third preset position, and the flight tilt angle. The third preset position is at a certain height above a preset return position. The height is preset based on flight safety. The flight tilt angle may be determined according to the velocity of the UAV. For example, the flight tilt angle may be determined according to a maximum return velocity. The maximum return velocity includes two components: the maximum horizontal return speed and the maximum vertical return speed.

At 103, the UAV is controlled to fly from the second preset position to the third preset position along a direction indicated by the flight tilt angle. The third preset position is above the preset return position. The direction indicated by the flight tilt angle is also referred to as a “flight tilt angle direction.”

At 104, the UAV is controlled to land from the third preset position to the preset return position along a vertical direction.

In some embodiments, the UAV is controlled to fly from the second preset position to the third preset position along the flight tilt angle direction. Then, the UAV is controlled to land from the third preset position to the preset return position along the vertical direction.

The method provided by the embodiments reduces the return time by controlling the UAV to first fly along a straight line and then fly in the flight tilt angle direction. As such, the usage of the battery of the UAV is reduced, and various risks caused by the lack of power may further be reduced during the return process, thereby improving the safety of the UAV's automatic return.

Based on the above, in some embodiments, the following operations may also be performed before 102.

The maximum horizontal return speed and the maximum vertical return speed of the UAV may be obtained.

The flight tilt angle may be obtained according to the maximum horizontal return speed and the maximum vertical speed.

In an implementation manner of the present disclosure, the flight tilt angle may be obtained as the arctangent of a result of the maximum vertical return speed divided by the maximum return horizontal.

For example, the maximum horizontal return speed is v1 and the maximum vertical return speed is v2, and hence the flight tilt angle α is arctan(v2/v1).

Based on the above, in some embodiments, the method of embodiments of the present disclosure may also include the following processes.

The position information of the first preset position may be determined according to an initial position of the UAV and a first preset height.

The position information of the third preset position may be determined according to the preset return position and a second preset height.

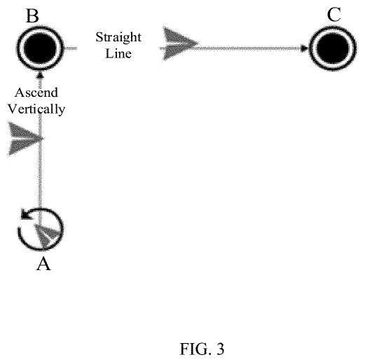

In some embodiments, as shown in FIG. 3, the UAV ascends vertically from the position of the UAV at the time the automatic return begins, i.e., the initial position of return (point A in FIG. 3) to the first preset position (point B in FIG. 3). The position information of the first preset position may be determined according to the initial position of return and the first preset height. The first preset height may be determined according to the actual environment of the area that the UAV passes through during the return process. That is, the first preset height may be preset based on the flight safety consideration of the UAV. In some embodiments, the first preset height may be set by the user through the user interface of the control terminal.

As shown in FIG. 2, the UAV is controlled to fly from the first preset position (point B in FIG. 2) to the second preset position (point C in FIG. 2) along the horizontal direction, then the UAV is controlled to fly from the second preset position to the third preset position (point D in FIG. 2) along the flight tilt angle direction. Finally, the UAV is controlled to land from the third preset position to the preset return position (point E in FIG. 2) along the vertical direction.

The position information of the third preset position may be determined before the UAV flies from the second preset position to the third preset position along the flight tilt angle direction. The third preset position is above the preset return position. The position information of the third preset position may be determined according to the preset return position and the second preset height. The second preset height may be determined according to the actual environment of the area that the UAV passes through during the vertical landing process. That is, the preset second height may be preset based on the flight safety consideration of the UAV. For example, the second preset height maybe 50 m. In some embodiments, the second preset height may be set by the user through the user interface of the control terminal.

Based on the above, in some embodiments, methods of embodiments of the present disclosure may also include the following.

A fourth preset position that is above the third preset position and is at the same height as the first preset position may be determined according to the position information of the third preset position.

A distance between the second preset position and the fourth preset position may be determined according to a height difference between the fourth preset position and the third preset position, and the flight tilt angle.

The second preset position may be determined according to the distance between the second preset position and the fourth preset position, and the position information of the fourth preset position. The height of the second preset position is the same as the height of the fourth preset position.

In some embodiments, as shown in FIG. 2, the fourth preset position is point F. A distance L between point C and point F is determined according to the height difference h (between point F and point D) and the flight tilt angle α. The second preset position, that is, point C, may be determined according to the position information of distance from point F.

Based on the above, in some embodiments, 103 may be implemented by using the following manners.

The UAV is controlled to fly from the second preset position to the third preset position along the flight tilt angle direction according to the maximum horizontal return speed and the maximum vertical return speed.

In some embodiments, as shown in FIG. 2, during the flight from point C to point D, the UAV is controlled to fly to the third preset position (point D) with the maximum return velocity along the flight tilt angle direction. The maximum return speed includes the maximum horizontal return speed and the maximum vertical return speed. The combined velocity direction of the maximum horizontal return speed and the maximum vertical return speed is the flight tilt angle direction. The direction of the combined speed of the UAV remains unchanged during the oblique flight.

Based on the above, in some embodiments, the following operations may be performed before 101.

A UAV nose is controlled to rotate toward the return direction, such that the UAV nose points to the return direction.

In some embodiments, as shown in FIG. 3, the UAV nose may be controlled to turn to the return direction before the UAV ascends vertically to the first preset position, such that the UAV nose points in the return direction. The return direction is consistent with the horizontal direction along which the UAV flies from the first preset position to the second preset position along the horizontal direction.

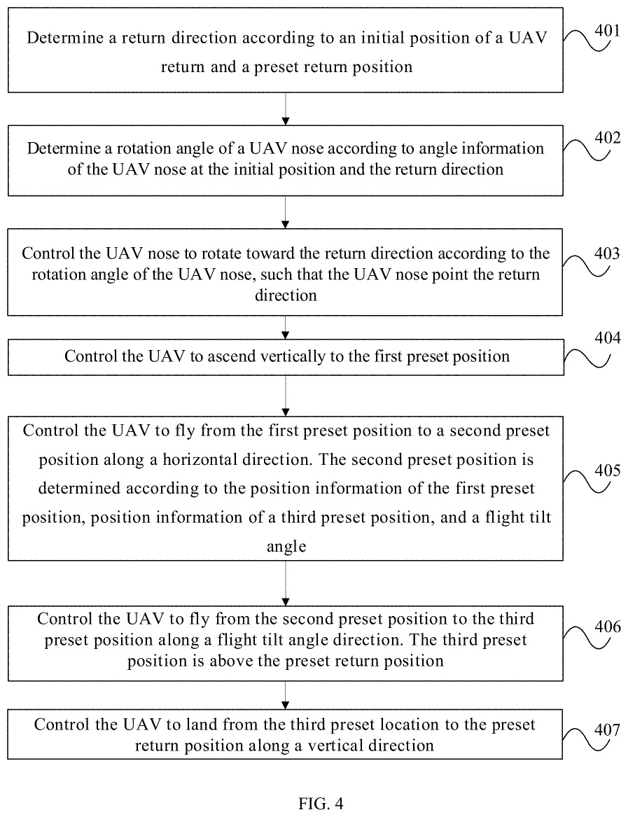

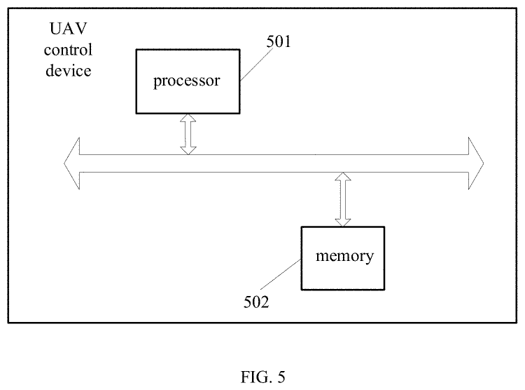

FIG. 4 is a flow chart of another UAV return method consistent with the disclosure.

At 401, a return direction is determined according to an initial position of UAV return and a preset return position.

At 402, a rotation angle of a UAV nose is determined according to angle information of the UAV nose at the initial position and the return direction.

At 403, the UAV nose is controlled to rotate toward the return direction according to the rotation angle of the UAV nose, such that the UAV nose points to the return direction.

In some embodiments, the return direction of the UAV may be determined according to the initial position of UAV return and the preset return position. That is, the direction of the horizontal component of the line from the initial position to the preset return position is the return direction.

A rotation angle of the UAV nose may be determined according to the angle information of the UAV nose at the initial position and the return direction. The UAV nose is controlled to rotate toward the return direction according to the rotation angle of the UAV, such that the UAV nose points to the return direction.

At 404, the UAV is controlled to ascend vertically to the first preset position.

At 405, the UAV is controlled to fly from the first preset position to the second preset position along the horizontal direction. The second preset position is determined according to the position information of the first preset position, the position information of the third preset position, and the flight tilt angle.

At 406, the UAV is controlled to fly from the second preset position to the third preset position along the flight tilt angle direction. The third preset position is above the preset return position.

At 407, the UAV is controlled to land vertically from the third preset position to the preset return position.

For the details of 404 to 407, reference may be made to 101 to 104, which will not be repeated here.

Based on the above, the method in some embodiments also includes determining whether the UAV meets a condition for returning (also referred to as “return condition”) and executing the process of controlling the UAV to ascend vertically to the first preset position when the UAV meets the return condition.

In some embodiments, whether the return condition is met needs to be determined before the UAV performs the automatic return. If the return condition is met, the UAV starts to execute the automatic return process, such as 101 or 403.

In an implementation manner of the present disclosure, the UAV meeting the return condition includes one or more of the followings.

The difference between the remaining power of the UAV's battery and the power required for the UAV to return is less than or equal to a preset power threshold.

A time period during which the UAV is disconnected from the control terminal is longer than a time threshold. The time period during which the UAV is disconnected from the control terminal is also referred to as a “disconnection time” of the UAV.

The UAV receives a return instruction from the control terminal.

In some embodiments, when the UAV meets one, or a combination of more than one, of low power, disconnection, and receiving return instruction, the UAV may be considered to meet the return condition, and the UAV starts to execute the automatic return process.

In some embodiments, low power indicates that the difference between the remaining power of the UAV's battery and the power required for the UAV to return is less than or equal to a preset power threshold. Disconnection indicates that the disconnection time of the UAV is longer than a time threshold.

In some embodiments, the control terminal includes a UAV controller or other terminal device.

According to methods consistent with the disclosure, the UAV nose is rotated toward the return direction when the UAV needs to return, then the UAV ascends vertically to the first preset position, and then the UAV flies horizontally from the first preset position to the second preset position along a straight line and flies obliquely in the flight tilt angle direction. As such, the flight method shortens the return time, reduces the usage of the UAV's battery power, and further reduces various risks caused by the lack of power during the UAV return process, thereby improving the safety of the UAV's automatic return.

FIG. 5 is a schematic structural diagram of a UAV control device according to some embodiments of the present disclosure. The control device is configured to execute the UAV return method provided by any of the above-described embodiments. As shown in FIG. 5, the UAV control device includes a processor 501 and a memory 502. The memory 502 is configured to store instructions.

The processor 501 is configured to execute the instructions to control the UAV to ascend vertically to the first preset position, and control the UAV to fly from the first preset position to the second preset position along the horizontal direction, where the second preset position may be determined according to the position information of the first preset position, the position information of the third preset position, and the flight tilt angle.

The processor 501 is also configured to execute the instructions to control the UAV to fly from the second preset position to the third preset position along the flight tilt angle direction, and control the UAV to land vertically from the preset third position to the preset return position, where the third preset position is above the preset return position.

In an implementation manner, the processor may also be configured to acquire a maximum horizontal return speed and a maximum vertical return speed of the UAV, and determine a flight tilt angle according to the maximum horizontal return speed and the maximum vertical return speed.

In an implementation manner, the processor may be specially configured to determine the flight tilt angle as the arctangent of a result of the maximum vertical return speed divided by the maximum horizontal return speed.

In an implementation manner, the processor may also be configured to determine position information of the first preset position according to an initial position of the UAV and a first preset height, and determine position information of the third preset position according to the preset return position and a second preset height.

In an implementation manner, the processor may also be configured to determine a fourth preset position according to position information of the third preset position, and determine a distance between the second preset position and the fourth preset position according to a height difference between the fourth preset position and the third preset position, and the flight tilt angle. The fourth preset position may be above the third preset position and at the same height as the first preset position.

In an implementation manner, the processor may be configured to determine the second preset position according to the distance between the second preset position and the fourth preset position, and position information of the fourth preset position. The fourth preset position may be at the same height as the second preset position.

In an implementation manner, the processor may be further configured to control the UAV to fly from the second preset position to the third preset position along the flight tilt angle direction according to the UAV's maximum horizontal return speed and maximum vertical return speed.

In an implementation manner, the processor may be further configured to control a UAV nose to rotate toward the return direction, such that the UAV nose points to the return direction.

In an implementation manner, the processor may be further configured to determine a return direction according to the UAV's initial position and the preset return position, and determine a rotation angle of the UAV nose according to angle information of the UAV nose at the initial position and the return direction.

In an implementation manner, the processor may be further configured to control the UAV nose to rotate toward the return direction according to the rotation angle of the UAV nose, such that the UAV nose points to the return direction.

In an implementation manner, the processor may be further configured to determine whether the UAV meets a return condition, and execute the process of controlling the UAV to ascend vertically to the first preset position when the UAV meets the return condition.

In an implementation manner, the UAV meeting the return condition includes one or more of the followings.

The difference between the remaining power of the UAV's battery and the power required for the UAV to return is less than or equal to a preset power threshold.

The disconnection time, during which the UAV is disconnected from the control terminal, is longer than a time threshold.

The UAV receives the return instruction from the control terminal.

The UAV control device is configured to execute the UAV return method provided by any above-described embodiments. The technical principles and technical effects are similar and are not repeated here.

Embodiments of the present disclosure also provide a UAV. The UAV includes a UAV body, a propulsion system arranged at the UAV body and configured to provide propulsion for the UAV to move, and a UAV control device consistent with any one of the above-described embodiments, the technical principles and technical effects of which are similar and are not repeated here.

The UAV provided by the embodiments of the present disclosure may be a multi-rotor UAV. In some embodiments, the UAV may be a quadrotor UAV, a hexarotor UAV, or an octorotor UAV. The UAV of the present disclosure may be a vertical take-off-landing UAV or a fixed-wing UAV.

Embodiments of the present disclosure also provide a computer-readable storage medium. The storage medium stores a computer program. When the computer program is executed by the processor, a corresponding method in the above-described method embodiments is implemented. The above-described method embodiments can be referred to for the specific implementation process. The technical principles and technical effects are similar and are not repeated here.

Embodiments of the present disclosure also provide a program product. The program product includes a computer program (that is, executable instructions). The computer program is stored in a readable storage medium. A processor may read the computer program from the readable storage medium. The processor may execute the computer program to execute a UAV return method provided by any of the above-described method embodiments.

Those of ordinary skill in the art may understand that all or part of the processes in the above-described method embodiments may be implemented by a program instructing relevant hardware. The program may be stored in a computer-readable storage medium. When the program is executed, a method consistent with the disclosure, such as one of the above-described example methods is performed. The storage medium includes ROM, RAM, magnetic disk, optical disk, or another media that can store program codes.

Finally, the above-described embodiments are merely used to illustrate the technical solutions of the embodiments of the present disclosure, but not to limit the present disclosure. Although the embodiments of the present disclosure are described in detail with reference to the above-described embodiments, those of ordinary skill in the art would understand that the technical solutions in the above-described embodiments can be modified, or some or all of the technical features thereof can be equivalently replaced. However, these modifications or replacements do not cause the essence of the corresponding technical solutions to deviate from the scope of the technical solutions of the embodiments of the present disclosure.

What is claimed is:

1. An unmanned aerial vehicle (UAV) return method comprising:
controlling a UAV to ascend vertically to a first preset position;
controlling the UAV to fly from the first preset position to a second preset position along a horizontal direction, the second preset position being determined according to position information of the first preset position, position information of a third preset position, and a flight tilt angle;
controlling the UAV to fly from the second preset position to the third preset position along a flight tilt angle direction indicated by the flight tilt angle, the third preset position being above a preset return position; and
controlling the UAV to land vertically from the third preset position to the preset return position.

2. The method according to claim 1, further comprising, before controlling the UAV to fly from the first preset position to the second preset position:
obtaining a maximum horizontal return speed and a maximum vertical return speed of the UAV; and
determining the flight tilt angle according to the maximum horizontal return speed and the maximum vertical return speed of the UAV.

3. The method according to claim 2, wherein determining the flight tilt angle according to the maximum horizontal return speed and the maximum vertical return speed of the UAV includes:
determining the flight tilt angle as an arctangent of a value obtained by dividing the maximum vertical return speed by the maximum horizontal return speed.

4. The method according to claim 1, further comprising, before controlling the UAV to ascend vertically to the first preset position:
determining the position information of the first preset position according to an initial position of the UAV and a first preset height; and
determining the position information of the third preset position according to the preset return position and a second preset height.

5. The method according to claim 1, further comprising:
determining, according to the position information of the third preset position, a fourth preset position that is above the third preset position and at a same height as the first preset position;
determining a distance between the second preset position and the fourth preset position according to a height difference between the fourth preset position and the third preset position, and the flight tilt angle; and
determining the second preset position according to the distance between the second preset position and the fourth preset position, and position information of the fourth preset position.

6. The method according to claim 1, wherein controlling the UAV to fly from the second preset position to the third preset position includes:
controlling the UAV to fly from the second preset position to the third preset position along the flight tilt angle direction according to the maximum horizontal return speed and the maximum vertical return speed of the UAV.

7. The method according to claim 1, further comprising, before controlling the UAV to ascend vertically to the first preset position:
controlling a UAV nose to rotate to point to a return direction.

8. The method according to claim 7, further comprising, before controlling the UAV nose to rotate:
determining the return direction according to an initial position of the UAV and the preset return position; and
determining a rotation angle of the UAV nose according to angle information of the UAV nose at the initial position of the UAV and the return direction.

9. The method according to claim 8, wherein controlling the UAV nose to rotate includes:
controlling the UAV nose to rotate toward the return direction according to the rotation angle.

10. The method according to claim 1, further comprising:
determining whether the UAV meet a return condition;
wherein controlling the UAV to ascend vertically to the first preset position includes controlling the UAV to ascend vertically to the first preset position in response to determining that the UAV meets the return condition.

11. The method according to claim 10, wherein the return condition includes at least one of:
a difference between a remaining power of a battery of the UAV and a power required for the UAV to return to the preset return position being less than or equal to a preset power threshold;
a time period during which the UAV is disconnected from a control terminal being longer than a time threshold; or
receiving a return instruction from the control terminal.

12. A control device comprising:
a storage medium storing instructions; and
a processor configured to execute the instructions to:
control an unmanned aerial vehicle (UAV) to ascend vertically to a first preset position;
control the UAV to fly from the first preset position to a second preset position along a horizontal direction, the second preset position being determined according to position information of the first preset information, position information of a third preset information, and a flight tilt angle;
control the UAV to fly from the second preset position to the third preset position along a flight tilt angle direction indicated by the flight tilt angle, the third preset position being above a preset return position; and
control the UAV to land vertically from the third preset position to the preset return position.

13. The control device according to claim 12, wherein the processor is further configured to execute the instructions to:
obtain a maximum horizontal return speed and a maximum vertical return speed of the UAV; and
determine the flight tilt angle according to the maximum horizontal return speed and the maximum vertical return speed of the UAV.

14. The control device according to claim 13, wherein the processor is further configured to execute the instructions to:
determine the flight tilt angle as an arctangent of a value obtained by dividing the maximum vertical return speed by the maximum horizontal return speed.

15. The control device according to claim 12, wherein the processor is further configured to execute the instructions to:
determine the position information of the first preset position according to an initial position of the UAV and a first preset height; and
determine the position information of the third preset position according to the preset return position and a second height.

16. The control device according to claim 12, wherein the processor is further configured to execute the instructions to:
determine a fourth preset position that is above the third preset position and at a same height as the first preset position, according to the position information of the third preset position;
determine a distance between the second preset position and the fourth preset position according to a height difference between the fourth preset position and the third preset position, and the flight tilt angle; and
determine the second preset position according to the distance between the second preset position and the fourth preset position, and position information of the fourth preset position.

17. The control device according to claim 12, wherein the processor is further configured to execute instructions to:
control the UAV to fly from the second preset position to the third preset position along the flight tilt angle direction according to the maximum horizontal return speed and the maximum vertical return speed of the UAV.

18. The control device according to claim 12, wherein the processor is further configured to execute instructions to:
control a UAV nose to rotate toward point to a return direction.

19. The control device to claim 18, wherein the processor is further configured to execute instructions to:
determine the return direction according to an initial position of the UAV and the preset return position; and
determine a rotation angle of the UAV nose according to angle information of the UAV nose at the initial position of the UAV and the return direction.

20. An unmanned aerial vehicle (UAV) comprising:
a UAV body;
a propulsion system arranged at the UAV body and configured to provide propulsion for the UAV to move; and
a control device including:
a storage medium storing instructions; and
a processor configured to execute the instructions to:
control the UAV to ascend vertically to a first preset position;
control the UAV to fly from the first preset position to a second preset position along a horizontal direction, the second preset position being determined according to position information of the first preset information, position information of a third preset information, and a flight tilt angle;
control the UAV to fly from the second preset position to the third preset position along a flight tilt angle direction indicated by the flight tilt angle, the third preset position being above a preset return position; and
control the UAV to land vertically from the third preset position to the preset return position.
